(19) United States
(12) Patent Application Publication
(10) Pub. No.: US 2015/0109129 A1
(43) Pub. Date: Apr. 23, 2015

(54) SYSTEM AND METHOD FOR MEASURING BODILY IMPACT EVENTS

(71) Applicant: Brain Sentry LLC, Bethesda, MD (US)

(72) Inventors: Gregory L. Merril, Bethesda, MD (US); Robert F. Cohen, Kensington, MD (US); Andrew Lipovsky, Oakton, VA (US)

(21) Appl. No.: 14/517,615

(22) Filed: Oct. 17, 2014

Related U.S. Application Data
(60) Provisional application No. 61/892,659, filed on Oct. 18, 2013.

(51) Int. Cl. G01L 5/00; G08B 21/04; G01P 15/02; A42B 3/04; A42B 1/24

(52) U.S. Cl. CPC G01L 5/0052; A42B 3/046; A42B 3/0453; A42B 3/044; A42B 1/242; G01P 15/02; G08B 21/0438
USPC 340/573.1; 702/141

(57) ABSTRACT

A system for detecting head impacts comprises a sensor for detecting acceleration and providing a signal representative of applied impacts, a display, and a processor. The processor is configured to receive data from the acceleration sensor and determine whether a magnitude of an impact exceeds a threshold. In response to a magnitude of an impact exceeding the threshold, the system displays a cumulative report of impacts exceeding the threshold.

### BACKGROUND

1. Technical Field

Present invention embodiments relate to acceleration and impact measurement and, more specifically, to detecting and measuring impacts to a person's head.

2. Discussion of the Related Art

In many sports, athletes sustain brain injuries despite the use of protective headgear (e.g., helmets). In particular, mild traumatic brain injury (mTBI, also referred to as a “concussion”) is among the most common reported injuries in organized youth sports. These brain injuries are not always readily apparent or detectable when they first occur. As a result, athletes sometimes continue to play, unaware that they are at risk for further injury with potentially debilitating and long-term consequences.

### SUMMARY

Present invention embodiments detect and measure bodily impacts to enable identification of individuals to be evaluated for a concussion (e.g., after detection of a large impact or acceleration to the head or a large accumulation of impacts within a short period of time (e.g., 1 hour, 24 hours, a week, etc.)) or rested after experiencing a lesser accumulation of plural impacts or accelerations to the head within a period of time (e.g., 1 hour, 24 hours, a week, etc.).

An impact detection system of a present invention embodiment includes one or more linear accelerometers (e.g., tri-axial accelerometers, etc.) and supporting circuitry (e.g., microcontroller, etc.) to identify impacts or accelerations that meet one or more threshold criteria (e.g., peak linear acceleration thresholds, thresholds on measures that take into account linear acceleration and event duration (e.g., a head injury criterion (HIC) calculation, etc.), etc.). The impact detection system may be mounted on or integrated into a helmet, headband, cap, eyewear, or the like, or otherwise secured to or proximate a person's head.

A count is displayed via a liquid-crystal display (LCD) or other display of the impact detection system in response to an impact event satisfying the threshold criteria. The count indicates a total number of detected accelerations satisfying the criteria. In addition, a second count tracks the number of impact events for a trailing period of time (e.g., the trailing seven days, etc.). The impact detection system display provides the cumulative total number of detected impacts or accelerations and the number of detected impacts or accelerations for the trailing period of time (e.g., trailing seven days, etc.). The impact detection system may be configured to display the number of detected impacts for various and multiple trailing periods (e.g. tailing twelve hours and trailing seven days).

In addition, a present invention embodiment may include a light emitting diode (LED), sound output, and/or tactile output (e.g., audible alarm, buzzer, etc.) that indicates an alert for a high impact event (e.g., a detected acceleration of 400 g with a minimum duration that exceeds 6 milliseconds (ms) and/or 90% of the time of the impact event). The cumulative count includes impacts at a lower degree than the high impact event.

The above and still further features and advantages of the present invention will become apparent upon consideration of the following detailed description of example embodiments thereof, particularly when taken in conjunction with the accompanying drawings wherein like reference numerals in the various figures are utilized to designate like components.

### BRIEF DESCRIPTION OF THE SEVERAL VIEWS OF THE DRAWINGS

FIG. 1 is a view in perspective of an impact detection system according to an embodiment of the present invention.

FIG. 2 is a view in perspective of a football helmet bearing the impact detection system of FIG. 1.

FIG. 3 is a view in perspective of a football helmet illustrating energy absorption in various directions.

FIG. 4 is a view in perspective of a lacrosse helmet illustrating energy absorption in various directions.

FIG. 5 is a block diagram of a circuit of the impact detection system according to an embodiment of the present invention.

FIG. 6 is a procedural flow chart illustrating a manner of initializing the impact detection system at startup according to an embodiment of the present invention.

FIG. 7 is a procedural flow chart illustrating a manner of handling a timer interrupt within the impact detection system according to an embodiment of the present invention.

FIG. 8 is a procedural flow chart illustrating a manner of handling an accelerometer interrupt within the impact detection system according to an embodiment of the present invention.

FIG. 9 is a procedural flow chart illustrating a manner of recording an acceleration event within the impact detection system according to an embodiment of the present invention.

FIG. 10 is a procedural flow chart illustrating a manner of handling a user action within the impact detection system according to an embodiment of the present invention.

### DETAILED DESCRIPTION

According to one embodiment of the present invention, an impact detection system attaches to a player's helmet and detects impacts that could cause a concussion. The system includes one or more sensors (e.g., micro-electromechanical system (MEMS) sensors or other sensors to measure linear acceleration, rotation, temperature, etc.) and a display to indicate impacts. The sensors can be calibrated to match various types of helmets, the size and age of the wearer, and particular sports or activities. Small volume and low weight make the device unobtrusive to the wearer.

One aspect of an embodiment of the present invention is an impact and acceleration detector that reconstructs impacts to the head based on the response of signals from an acceleration sensor system, taking into account direction-dependent energy absorption of various types of helmets.

Another aspect of a present invention embodiment is to present indications of impacts, including reports of cumulative impacts, according to a plurality of impact thresholds. For example, the impact detection system can be calibrated to report counts of impacts above a predetermined threshold and to signal alerts at a higher impact threshold. Any number of alert signals or displays may be implemented.

Impact thresholds may be based on one or more impact metrics. One metric on which to base impact thresholds is the peak acceleration magnitude. Another metric is the head injury criterion (HIC) value, given by

$$HIC = {\{ {[ \frac{1}{{t}_{2} - {t}_{1}} {\int }_{{t}_{1}}^{{t}_{2}} a ( t ) d t ]}^{2.5} ( {t}_{2} - {t}_{1} ) \}}_{ma x}$$

where t₁ and t₂ are the initial and final times (in seconds) of the interval during which HIC attains a maximum value, and acceleration a is measured in units of g (standard gravity acceleration). The maximum time duration of HIC, t₂−t₁, may be limited to a specific value, usually 15 milliseconds.

HIC includes the effects of head acceleration and the duration of the acceleration. At a HIC of 1000, one in six people will suffer a life-threatening injury to their brain (more accurately, an 18% probability of a severe head injury, a 55% probability of a serious injury and a 90% probability of a moderate head injury to the average adult). HIC is used to determine the U.S. National Highway Traffic Safety Administration (NHTSA) star rating for automobile safety and to determine ratings given by the Insurance Institute for Highway Safety. Sport physiologists and biomechanics experts use the HIC in the research of safety equipment and guidelines for competitive sport and recreation. In one study, concussions were found to occur at HIC=250 in most athletes. Studies have been conducted in skiing and other sports to test adequacy of helmets.

Still another metric is an impact “dose,” which represents a cumulative effect of impacts. An impact dose may be a sum of a quantity (e.g., a unit value, the peak magnitude of acceleration, HIC value, or the like) for hits above a threshold (e.g., minimum acceleration of 30 g, 40 g, 60 g, 80 g, etc.) within a preceding time (e.g., 1 hour, 24 hours, 1 week, time since power on, etc.). For example, the impact dose may be the number of impacts with peak acceleration above 60 g within the preceding 24 hours; alternatively (or in addition), an impact dose may be the sum of peak acceleration magnitudes (or of HIC values, etc.) of hits within the past week. The quantity contributed by an impact to the sum may be reduced (e.g., exponentially, linearly, etc.) according to the time elapsed since the impact so that less recent impacts contribute less to the impact dose. For example, the quantity associated with each impact may be scaled down by a constant factor at regular time intervals until the quantity falls below a minimum threshold, after which the impact is disregarded with respect to the impact dose.

With reference now to the Figures, an example impact detection system 100 according to an embodiment of the present invention is illustrated in FIG. 1. The impact detection system may comprise an enclosure or housing 120 and a variety of user interface components. Enclosure 120 contains a motherboard, microcontroller, and sensors. The enclosure may have length, width, and height dimensions at least as small as 3.3″×1.4″×0.5″, and the impact detection system may have a weight at least as low as thirty grams. The enclosure may be constructed of rigid plastic (e.g., an injection molded polycarbonate) and may be watertight, water-resistant, etc. The enclosure includes front, rear, and side surfaces that form a generally rectangular block with tapered longitudinal portions. The bottom outer surface may be concave to match a convex outer surface of a rounded helmet and may be attached to a helmet or other article.

The user interface components are disposed on the enclosure front surface and may comprise button 520, liquid-crystal display (LCD) 580, and light emitting diode (LED) display 595 positioned between the button and LCD display. Button 520 may be used to engage power to the device and interact with the device once power is engaged. LCD 580 may display a count 105 of impact events that satisfy a predetermined threshold (e.g., a threshold on an estimated acceleration of the center of gravity of the head). Impact events that exceed this threshold are referred to as “hits” or “hit events.” In addition, LCD 580 may display a count 110 of hits within a trailing time period (e.g., seven days). LCD 580 may display hit counts graphically or digitally. In one embodiment, LCD 580 is capable of displaying at least four numerical and/or alphabetical characters. LED display 595 may comprise red and green (or other colored) LEDs. The red LED indicates hits that exceed a higher threshold (or an accumulated hit dose that exceeds a threshold). Events exceeding the higher threshold are referred to as “alerts” or “alert events.” The green LED indicates that the device is functioning or provides other information (e.g., version information, etc.).

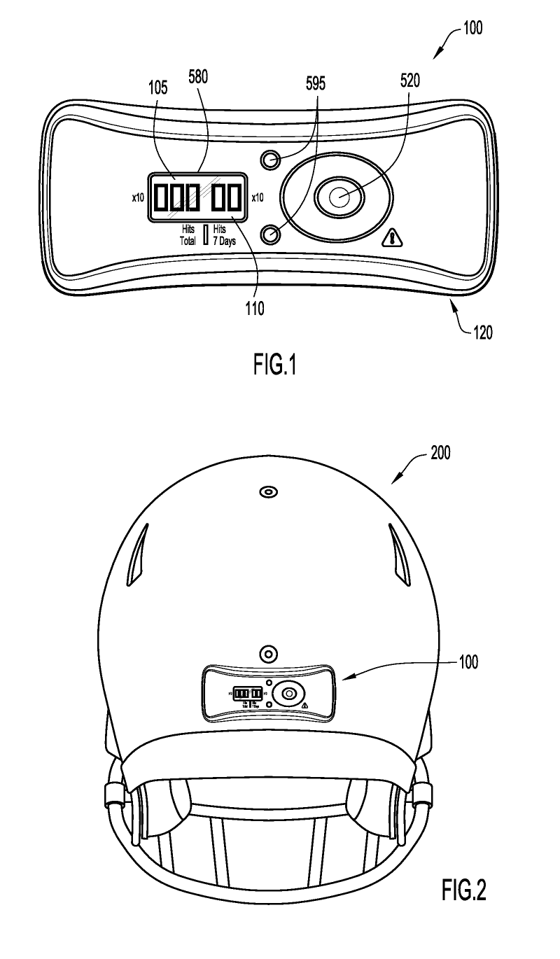

A helmet 200 with an attached impact detection system 100 according to an embodiment of the present invention is illustrated in FIG. 2. The impact detection system may attach to the external lower rear (or other location) of the helmet (e.g., via double-sided adhesive, such as 3M VHB modified acrylic adhesive, etc.). Although a football helmet is depicted by way of example, present invention embodiments may be used with any type of helmet or headgear, or may be otherwise secured to or proximate a person's head.

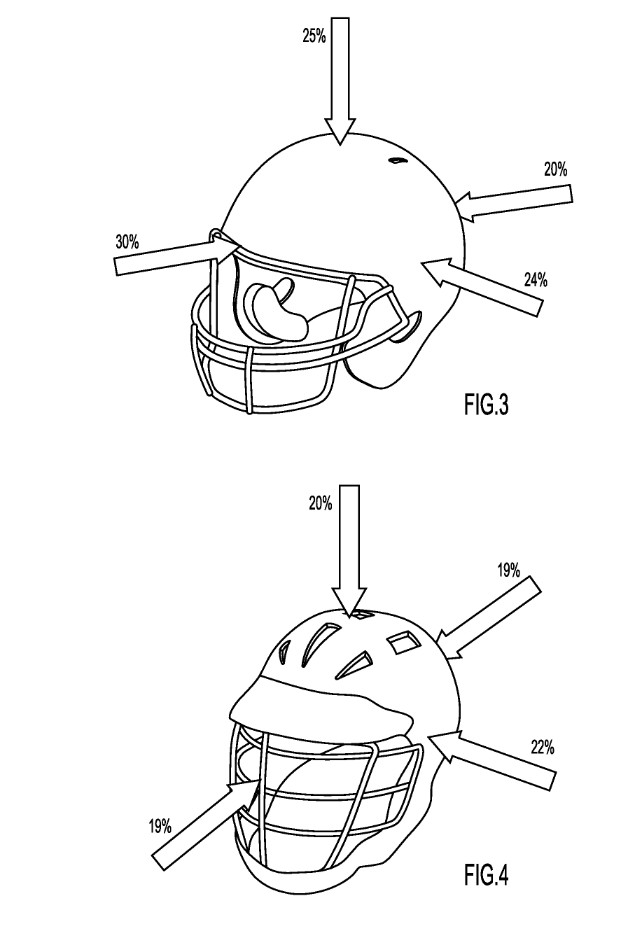

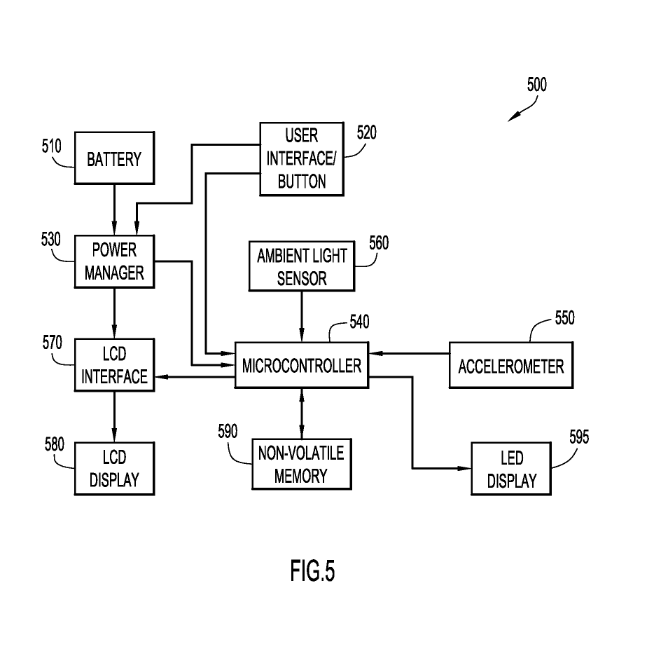

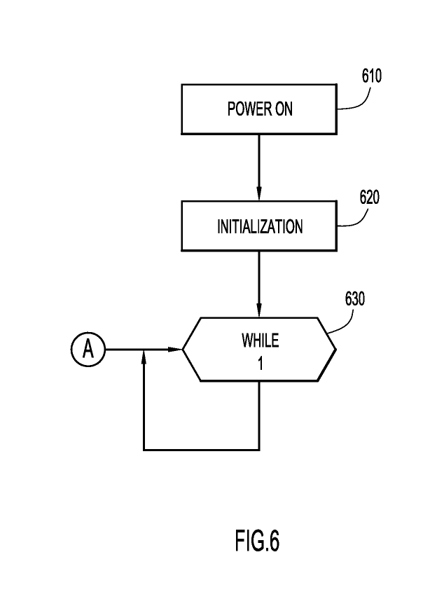

Most types of helmets respond differently to impacts from different directions. Illustrations of energy absorption in various directions are shown for football and lacrosse helmets in FIGS. 3 and 4, respectively. For example, a football helmet may transfer on average 30%, 25%, 20%, and 24% of the energy of impacts from the front, top, rear, and side, respectively, to the head, while a lacrosse helmet may transfer 19%, 20%, 19%, and 22% of the energy of impacts from corresponding directions. Variations in the effects of impacts with direction for different types of helmets may be taken into account in determining whether an impact satisfies impact thresholds.

A block diagram of a control circuit 500 of impact detection system 100 according to an embodiment of the present invention is illustrated in FIG. 5. Specifically, control circuit 500 includes a battery 510, a power manager 530, a microcontroller 540, an accelerometer 550, and an ambient light sensor 560. Battery 510 is connected to power manager 530 via a switch actuated by button 520. In one embodiment of the invention, the battery has a lifetime of about one year; the user cannot replace the battery, and the unit must be replaced at the end of the battery lifetime. Microcontroller 540 is connected by a serial peripheral interface (SPI) bus to accelerometer 550, an LCD interface component 570, and an external non-volatile (e.g., persistent) memory 590. Accelerometer 550 communicates interrupt signals to the microcontroller. LED display 595 is controlled by outputs from the microcontroller and is illuminated when certain conditions are met. External non-volatile memory 590 is used for storing and retrieving data.

Control circuit 500 operates in the following manner. When battery 510 is present, the user may enable the control circuit by pressing button 520. As a result, a transistor (e.g., a metal-oxide-semiconductor field-effect transistor (MOSFET), etc.) in power manager 530 latches closed, and a clock of microcontroller 540 starts running. A processor of microcontroller 540 begins instruction execution from internal memory, and uses the serial peripheral interface (SPI) bus to communicate with accelerometer 550. The instructions configure the microcontroller and accelerometer, and then set them in low power modes. The software for the impact detection system operates as an interrupt driven system. When the accelerometer senses acceleration above a particular threshold (e.g., 2.1 g, 3 g, etc.), it will assert an interrupt causing the microcontroller to exit low power mode and begin executing instructions to process data from the accelerometer. In this manner, the accelerometer may operate as a motion or vibration sensor to activate the device from low power mode (or off state). Alternatively, the impact detection system may include a separate motion or vibration sensor to activate the device from a low or off power state. If the result of this processing is above a particular higher threshold (e.g., 12 g), the microcontroller will execute algorithms to determine the direction of the acceleration and transform the event from the native coordinate frame of the accelerometer to the coordinate frame of interest (e.g., a coordinate frame based upon the user's head). If the result of this calculation is above a threshold T1 (e.g., 30 g), the event is a hit event, and the microcontroller will increment a first counter and log event data (which may include, e.g., date, time, magnitude, HIC value, etc.). If the calculation result is above a higher threshold T2 (e.g., 80 g), the event is referred to as an alert event, and the microcontroller will increment a second counter (also referred to as the “red light counter”) and log event data. An alert event also counts as a hit event. In addition, the microcontroller may calculate one or more impact dose metrics and the event may be considered an alert event if it causes an impact dose to exceed a corresponding predetermined threshold. If the accelerometer and microcontroller fail to detect acceleration above a set threshold for a set period of time, the control circuit enters low power mode.

Periodically, the microcontroller flashes LED display 595 to indicate the internal state. The green LED periodically flashes to indicate the device is working. The red LED periodically flashes a number of times corresponding to the number of events logged in the second counter. The microcontroller updates LCD display 580 by sending instructions to LCD interface 570. The microcontroller may, e.g., set the LCD display to show the number of events that exceeded threshold T1 since the device was turned on. The LCD may also show the number of events exceeding the threshold T1 in a trailing time period (e.g., seven days), an impact dose, or the like. Optionally, the microcontroller may set the LCD display to numbers of events-above-threshold scaled by a predetermined factor. For example, the LCD may show a number of events divided by ten.

User interface button 520 may enable a user to activate one or more functions described below. Ambient light sensor 560 provides data about the brightness of the environment of impact detection system 100 to the microcontroller. The microcontroller uses this data to control the LED brightness. Ambient light sensor 560 may also be used to communicate with the microcontroller wirelessly using infrared signals.

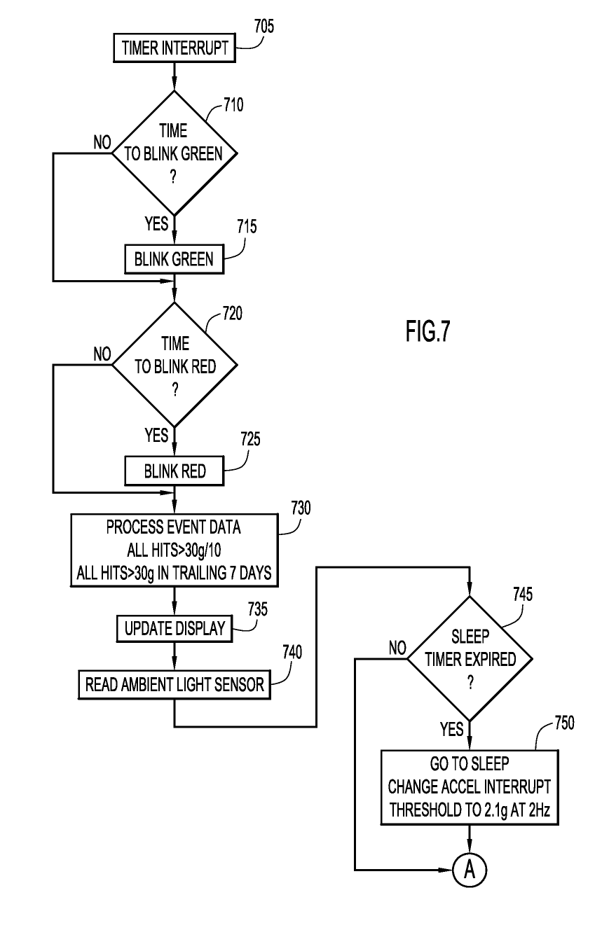

A manner of initializing the impact detection system at startup according to an embodiment of the present invention is illustrated in FIG. 6. At step 610, the system is powered on. For example, the system may be powered on when a user first presses button 520 and the MOSFET latches. Initialization and configuration is performed at step 620. The processor, serial peripheral interface (SPI), and accelerometer 550 are initialized, after which the impact detection system is set into low power mode, defined by the microcontroller architecture and instruction set.

During the processor initialization, the software instructs the microcontroller to set a main clock to run at 1 MHz and an auxiliary clock to be internally regulated and run at 12 kHz. A timer interrupt is set up to occur every second. A hardware interrupt is configured to read button 520 and output from accelerometer 550. Ports and pins are configured as input and output to read the button, set the LCD, and illuminate the LEDs or other indicator lights when instructed.

SPI initialization software sets up the control circuit to use a four wire serial SPI bus to communicate with the accelerometer and off board memory. SPI requires that each peripheral on the bus be addressable through a chip select signal and have a clock source configured.

The accelerometer initialization software directs the microcontroller to perform procedures that load parameters into the accelerometer describing the range for which it will report data, how the data will be reported, the behavior of the interrupts, the threshold at which the interrupt is triggered, and the speed of data acquisition. In one embodiment, the accelerometer operates at 1 kHz, will measure acceleration up to 400 g, is turned back to 100 g for low power operation, and will trigger a latching interrupt on a rising edge as long as the acceleration is greater than 3% of the range on any axis.

At step 630, the device enters low power mode. This turns off the clocks and peripherals except for the auxiliary clock running at 12 kHz. The device will return from low power mode to normal operation when an interrupt occurs. The device may return to low power mode at step A after handling of an interrupt completes. There are two types of interrupts: internally generated and externally generated.

Internally generated interrupts come from a timer, at a rate of 1 Hz. A manner of handling a timer interrupt according to an embodiment of the present invention is illustrated in FIG. 7. Initially, the processor of the microcontroller determines whether to blink the LEDs. In particular, when a timer interrupt occurs, at step 705, the processor decrements two counters: counter A (e.g., which counts down from five) and counter B, also referred to as the “sleep timer,” (e.g., which counts down from one hundred and fifty). At step 710, the processor determines whether counter A has reached zero. If so, counter A is reset (e.g., to five), and at step 715 the processor blinks the green LED to indicate that the device is awake and operating properly. At step 720, the processor determines whether there are any alert events. If so, the processor blinks the red LED at step 725. For example, the red LED may blink a number of times equal to the count of alert events.

The recorded data of impact detections is processed at step 730, and the results are displayed on the LCD screen at step 735. In one embodiment, two numbers are displayed on the LCD. The first number is the total number of hits, greater than 30 g, since the device has been turned on, divided by ten. The second number is the number of hits, greater than 30 g in a trailing time period (e.g., seven days or any other period). Alternatively, the data may be analyzed, and results displayed, to provide dosimeter-like behavior. For example, the display may report an impact dose metric (e.g., total of Head Injury Criterion (HIC) values accumulated since the device was turned on and in the trailing period, sum of acceleration magnitudes for hits in the preceding 24 hours, etc.).

Ambient light sensor 560 is read at step 740. The processor may control the brightness of the LEDs based on data about the environment from the light sensor. For example, on a bright sunny afternoon, the red LED may be set to maximum brightness. At night, the LEDs may be dimmer. The ambient light sensor may also be used to communicate with the device wirelessly using an infrared interface.

At step 745, the processor determines whether the sleep timer, counter B, has reached zero. If so, at step 750, the processor puts the accelerometer in sleep mode by setting its range to 100 g. its wake up threshold to 2.1 g, and the data rate to 2 Hz; in addition, the microcontroller is set to its lowest power setting. Processing then proceeds to step A.

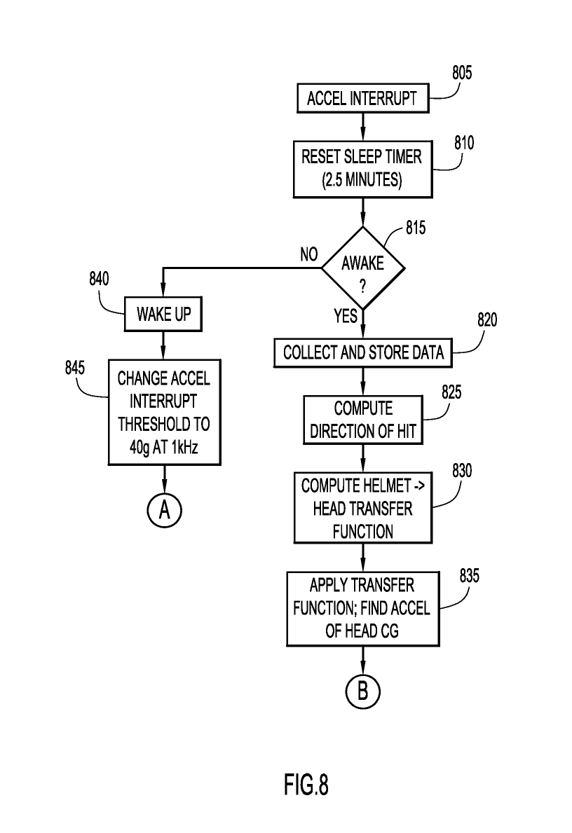

A manner of handling an acceleration event (e.g., via microcontroller 540) according to an embodiment of the present invention is illustrated in FIG. 8. In particular, an acceleration of impact detection system 100 triggers an acceleration interrupt at step 805. At step 810, counter B (the “sleep timer”) is reset (e.g., to one hundred and fifty, corresponding to two and a half minutes for timer interrupts at a rate of 1 Hz). At step 815, the processor determines whether the accelerometer was asleep. If so, the accelerometer is woken up at step 840, is put into its high performance mode at step 845, setting the data rate to 1 kHz, the range to 400 g and the threshold to 40 g. Processing then proceeds to step A, and the accelerometer is awake, awaiting an impact event.

If the device is awake at step 815, the data for a period of time (e.g., 50 ms) following the interrupt are recorded at step 820. Once the data are recorded, calculations are performed to determine the impact to the center of gravity of the head, taking into account variations in helmet performance with impact direction.

In particular, the calculation begins by computing the direction of impact at step 825. The direction of impact is computed with respect to a user head in, e.g., a right-handed Cartesian coordinate system centered at the center of gravity of the head, in which the x-axis points in the direction a wearer of the device faces, the y-axis extends through the sides of the wearer's head, and the z-axis points in the general direction toward the top of the wearer's head. An initial acceleration vector d, with components (aₓ, a_{y}, a_{z}), is computed from the data reported by accelerometer 550.

The initial acceleration vector \vec{a} has a magnitude |\vec{a}|=\sqrt{aₓ²+a_{y}²+a_{z}²}; an azimuthal angle α in the x-y plane, for which cos

$$α = {a}_{x} / \sqrt{{a}_{x}^{2} + {a}_{y}^{2}} ;$$

and an elevation angle γ with respect to the x-y plane, for which sin γ=a_{z}/|\vec{a}|.

At steps 830, 835, the acceleration of the center of gravity of the head \vec{h}=\vec{f}(\vec{a}) is determined based on \vec{a} and an experimentally-determined, direction-dependent transfer function \vec{ƒ} for the helmet. The magnitude h=|\vec{h}| is computed.

In an example embodiment of the present invention, the function \vec{ƒ} may have the form

$$\vec{f} ( \vec{a} ) = \vec{a} \times ( {c}_{α} + {c}_{γ} )$$

$$where$$

$${c}_{α} = \{ \begin{matrix}{c}_{0} & if & 1 / \sqrt{2} < cos α \leq 1 \\ {c}_{1} & if & - 1 / \sqrt{2} < cos α \leq 1 / \sqrt{2} \\ {c}_{2} & if & - 1 \leq cos α \leq - 1 / \sqrt{2}\end{matrix} \\ and \\ {c}_{γ} = \{ \begin{matrix}{c}_{3} & if & 1 / \sqrt{2} < sin γ \leq 1 \\ {c}_{4} & if & - 1 / \sqrt{2} < sin γ \leq 1 / \sqrt{2} \\ {c}_{5} & if & - 1 \leq sin γ \leq - 1 / \sqrt{2}\end{matrix} .$$

In other words, the transmission of the acceleration from the helmet to the center of gravity of the head may be characterized as depending upon whether the impact was to the front, back, or side of the helmet, and upon whether the impact was from the top, bottom, or horizontal direction with respect to the helmet. The parameters are generally in the range between zero and one, and vary based on the type and construction of a helmet. Example values of the parameters c₀, c₁, . . . c₅ for football, hockey, and lacrosse helmets are given in Table 1 below.

TABLE 1
Example transfer function parameters

| Parameter | Football | Hockey | Lacrosse |
|---|---|---|---|
| c₀ | 0.205 | 0.43 | 0.19 |
| c₁ | 0.24 | 0.49 | 0.20 |
| c₂ | 0.24 | 0.49 | 0.20 |
| c₃ | 0.18 | 0.23 | 0.19 |
| c₄ | 0.15 | 0.16 | 0.19 |
| c₅ | 0.14 | 0.16 | 0.18 |

In an alternative example, the direction cosine with respect to the x-axis, aₓ/|\vec{a}|, may be used in place of the cosine of the azimuth angle, cos α, and/or the cosine of the elevation angle γ may be used in place of the sine of the elevation angle. An embodiment of the present invention may use any functional form, with any set of parameters, for the transfer function.

An example manner of determining parameter values for a given parametric form of the transfer function according to an embodiment of the present invention is as follows. An anthropomorphic test device (ATD) head and neck assembly (e.g., a Humanetics Innovative Solutions® ATD, or other mannequin, crash test dummy, etc.) is configured in a test rig. A three-axis accelerometer is mounted inside the head and neck assembly at the approximate center of gravity of the assembly. A helmet of the type for which transfer parameters are to be determined is installed on the head. A three-axis accelerometer is attached to the helmet, and the helmet is subject to impacts of known energies and orientations. Acceleration data for each impact are recorded using any custom and/or commercially available data acquisition system and software (e.g, LabView®, etc.). A plurality of data runs (e.g., 10, 100, etc.) are performed at each orientation and energy level. A least squares regression is performed to determine parameters that map helmet acceleration to head acceleration for each particular orientation and to model the dependence of the acceleration transfer from helmet to head as a function of direction and/or magnitude of the helmet acceleration.

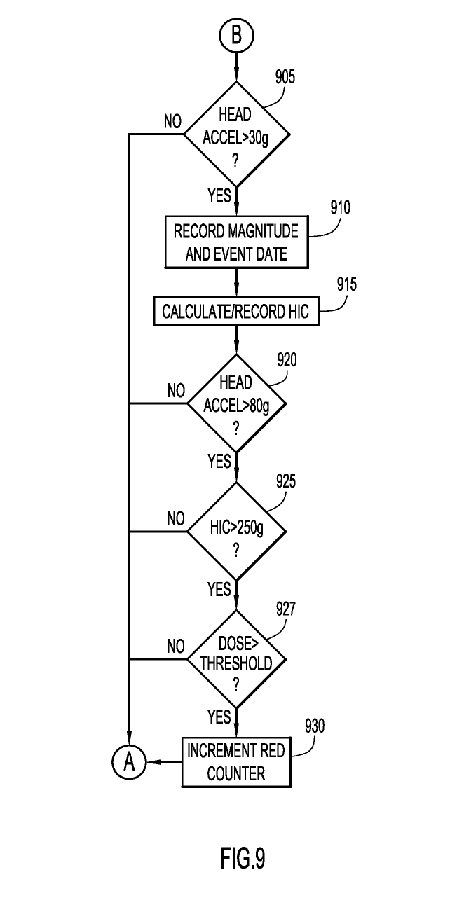

Given the magnitude h, a manner of handling the event according to an embodiment of the present invention is illustrated in FIG. 9. At step 905, it is determined whether to report the event. For example, if the processor determines that h is not greater than 30 g, processing proceeds to step A. Otherwise, the event data (e.g., magnitude h and date of the event) are stored at step 910. These data are used for setting the LCD to display hit counts, computing impact doses, and the like. In addition, the Head Injury Criterion (HIC) value for the event may be computed (e.g., using the acceleration h) and stored at step 915 for use in the dosimeter-type calculation and display.

After these calculations, a decision about the magnitude/severity of the impact is made. For example, if the head acceleration h is determined to be greater than 80 g at step 920, and the HIC value is determined to be greater than 250 at step 925, the event is considered an alert event, and the second (“red light”) counter is incremented at step 930. Alternatively, if the impact dose (e.g., the number of hits with h>60 g within the past 24 hours) is greater than a predetermined threshold (e.g., 2) at step 927, the event may be considered an alert event, and the second counter incremented at step 930. Processing returns to step A.

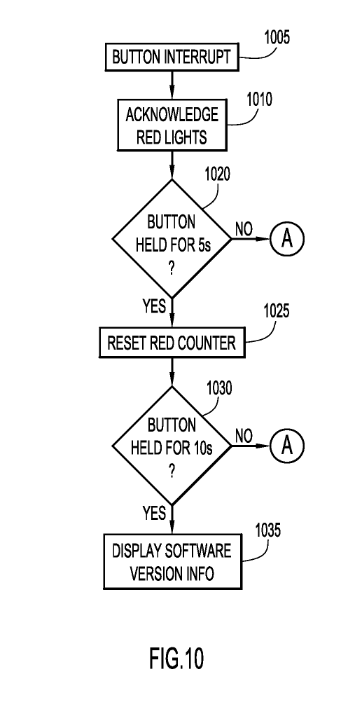

A manner of handling user interaction with the impact detection system according to an embodiment of the present invention is illustrated in FIG. 10. When button 520 is pressed, an interrupt is dispatched at step 1005. Alert events indicated by the red LED are acknowledged at step 1010: the alert events are not erased, but they will not be displayed by blinking the red LED until another alert event occurs. If the processor determines at step 1020 that the button is pressed and held for 5 seconds, indicated alert events will be acknowledged and then erased at step 1025. If the processor determines at step 1030 that the button is held for 10 seconds, the indicated alert events will be acknowledged, erased, and the red and green lights will flash in a pattern to indicate the software version and diagnostic information at step 1035. Processing then returns to step A.

It will be appreciated that the embodiments described above and illustrated in the drawings represent only a few of the many ways of implementing embodiments for detecting and measuring impacts to a person's head or headgear.

An impact detection system may be configured as an attachment to any kind of helmet (e.g., football, lacrosse, motorsports (e.g., ATV, go-cart, mini-bike, off-road), skateboarding, scooter riding, roller skating, boxing or other martial arts, hockey, skiing, snowboarding, sledding, snowmobiling, batter's helmet, construction hard hat, etc.) or other object (e.g., cap, hat, visor, headband, eyewear, etc.). The system may attach at any location of a helmet (e.g., top, front, interior surface, etc.) or other object. Alternatively, the sensors may be integrated into a helmet or other object (e.g., cap, hat, visor, headband, eyewear, etc.), or otherwise worn or secured to or proximate a person's head; for example, the sensors may be built into or onto a helmet or other object at the time the helmet or other object is manufactured.

An impact detection system may include any kind of acceleration sensor(s) (e.g., linear accelerometers, rotational sensors, etc.) and any kind of additional sensor(s) (e.g., light sensors, temperature sensors, etc.). The acceleration sensors may be any technology capable of measuring or detecting acceleration (e.g., microelectromechanical system (MEMS) sensors, gyroscopes, ceramic shear accelerometers, piezo vibration sensors, force switches, etc.). For example, the system may comprise a combination of MEMS accelerometers and piezo cantilevered sensors, where the MEMS are used as a duration measurement device and the piezo sensors are used for amplitude of impact. The impact detection system may have any dimensions and mass.

It is to be understood that the software of the present invention embodiments could be developed by one of ordinary skill in the computer arts based on the functional descriptions contained in the specification and flow charts illustrated in the drawings. Further, any references herein of software performing various functions generally refer to microcontroller processor(s) or other computer systems or processors performing those functions under software control. The computing systems of the present invention embodiments may alternatively be implemented by any type of hardware and/or other processing circuitry.

Present invention embodiments may include any number of any type(s) of microcontroller or other processing systems and storage systems (e.g., persistent memories, disk drives, etc.) arranged in any desired fashion, and may include any combination of commercially available and custom software (e.g., device driver software, event processing software, information storage software, etc.).

Present invention embodiments may employ any number of any type(s) of user interface for obtaining or providing information, where the interface may include any information arranged in any fashion. Present invention embodiments may include any types of display(s) (e.g., LCD, LED, audible, tactile, etc.) and input devices (e.g., button(s), infrared, keyboard, mouse, voice recognition, touch screen, etc.) to enter and/or view information. The interface may include any number of any types of input or actuation mechanisms (e.g., buttons, icons, fields, boxes, links, etc.) disposed at any locations to enter/display information and initiate desired actions (e.g. set the device manually to low power mode, clear memory, etc.) via any suitable input devices.

The various functions of the computer or other processing systems may be distributed in any manner among any number of software and/or hardware modules or units, processing or computer systems and/or circuitry. An impact detection system may include one or more communication modules (e.g., an infrared link, radio link (e.g., Wi-Fi, Bluetooth, etc.), data port (e.g., USB port, Ethernet port, etc.), etc.) for transmitting and/or receiving information. For example an end-user sensor system may transmit raw and/or processed acceleration or other event data directly or indirectly to a remote system (e.g., computing system, database system, handheld device, etc.) for analysis, storage, and/or reporting. One or more processing systems may be disposed locally or remotely of each other and communicate via any suitable communications medium (e.g., LAN, WAN, intranet, Internet, hardwire, modem connection, wireless (e.g., infrared, radio, etc.), etc.). The functions of the present invention embodiments may be distributed in any manner among various processing devices. The software and/or algorithms described above and illustrated in the flow charts may be modified in any manner that accomplishes the functions described herein. In addition, the functions in the flow charts or description may be performed in any order that accomplishes a desired operation.

Any number of data storage systems and structures may be used to store information. The data storage systems may be implemented by any number of any conventional or other databases, file systems, caches, repositories, warehouses, etc.

What is claimed is:

1. A system for detecting head impacts comprising:
a device including:
a sensor for detecting acceleration of the device and producing a signal indicating an impact;
a display for displaying at least one character; and
a processor configured to:
receive data from the sensor and determine a count of one or more impacts exceeding at least one predetermined threshold.

2. The system of claim 1, wherein the device is attached to a selected one of a helmet, cap, eyewear, and headband.

3. The system of claim 1, wherein the device is integrated into a selected one of a helmet, cap and headband.

4. The system of claim 1, further comprising at least one motion sensor to activate the device from a low power mode.

5. The system of claim 4, wherein the motion sensor turns on the device after the device has been turned off.

6. The system of claim 1 further comprising persistent memory storage.

7. The system of claim 1, wherein the display is a liquid crystal display (LCD).

8. The system of claim 1, further comprising a light emitting diode (LED) light, wherein the processor is further configured to turn the light on in response to at least one impact exceeding a predetermined threshold.

9. The system of claim 1, wherein the processor is further configured to:
provide an indication in response to the count exceeding a predetermined threshold.

10. The system of claim 1, wherein the processor is further configured to:
determine a magnitude for each of a plurality of impacts in response to receiving a corresponding signal from the sensor;
determine a modified set of magnitudes for a plurality of impacts, including one or more previous impacts by, reducing the magnitude for at least one of the previous impacts according to an elapsed time; and
determine an impact dose by summing each element of the modified set of magnitudes.

11. The system of claim 10, wherein the processor is further configured to:
display the impact dose on the display in response to an applied impact.

12. The system of claim 10, wherein the processor is further configured to:
display an indication of the impact dose at regular time intervals.

13. The system of claim 12, wherein the indication comprises a blinking sequence of lights.

14. The system of claim 10, wherein the device includes a light, and the processor is further configured to enable the light to indicate an alert in response to the impact dose exceeding a predetermined threshold.

15. The system of claim 10, wherein the device includes a sound generator, and the processor is further configured to enable the sound generator to generate a sound to indicate an alert in response to the impact dose exceeding a predetermined threshold.

16. The system of claim 10, wherein the device includes a tactile output generator, and the processor is further configured to enable the tactile output generator to generate a tactile output to indicate an alert in response to the impact dose exceeding a predetermined threshold.

17. The system of claim 10, wherein the device includes a wireless transmitter, and the processor is further configured to transmit an alert to a receiver via the wireless transmitter in response to an impact dose exceeding a predetermined threshold.

18. The system of claim 14, wherein the device further indicates an alert by a selected one of a tactile, audible, and wireless response.

19. A method for detecting head impacts comprising:
receiving data from a sensor for detecting acceleration and producing a signal indicating an impact;
determining a count of one or more impacts exceeding at least one predetermined threshold; and
displaying information about a least one of the one or more impacts on a character display.

20. The method of claim 19, wherein a device comprising the sensor and display is attached to a selected one of a helmet, cap, eyewear, and headband.

21. The method of claim 20, wherein the device is integrated into a selected one of a helmet, cap and headband.

22. The method of claim 20, further comprising activating the device from a low power mode in response to detecting motion of the device.

23. The method of claim 20, further comprising turning the device on in response to detecting motion of the device after the device has been turned off.

24. The method of claim 19, further comprising storing information about a least one of the one or more impacts in a persistent memory storage.

25. The method of claim 19, wherein the display is a liquid crystal display (LCD).

26. The method of claim 19, further comprising:
turning on a light emitting diode (LED) in response to at least one impact exceeding a predetermined threshold.

27. The method of claim 19, further comprising:
providing an indication in response to the count exceeding a predetermined threshold.

28. The method of claim 19, further comprising:
determining a magnitude for each of a plurality of impacts in response to receiving a corresponding signal from the sensor;
determining a modified set of magnitudes for a plurality of impacts, including one or more previous impacts by, reducing the magnitude for at least one of the previous impacts according to an elapsed time; and
determining an impact dose by summing each element of the modified set of magnitudes.

29. The method of claim 28, further comprising:
displaying the impact dose on the display in response to an applied impact.

30. The method of claim 28, further comprising:
displaying an indication of the impact dose at regular time intervals.

31. The method of claim 30, wherein the indication comprises a blinking sequence of lights.

32. The method of claim 28, further comprising:
enabling a light to indicate an alert in response to the impact dose exceeding a predetermined threshold.

33. The method of claim 28, further comprising:
generating a sound to indicate an alert in response to the impact dose exceeding a predetermined threshold.

34. The method of claim 28, further comprising:
generating a tactile output to indicate an alert in response to the impact dose exceeding a predetermined threshold.

35. The method of claim 28, further comprising:
transmitting an alert to a receiver via a wireless transmitter in response to an impact dose exceeding a predetermined threshold.

36. The method of claim 32, further comprising:
indicating the alert by a selected one of a tactile, audible, and wireless transmission response.
